(19) United States
(12) Patent Application Publication
(10) Pub. No.: US 2015/0181305 A1
(43) Pub. Date: Jun. 25, 2015

(54) RECEPTION APPARATUS, METHOD, AND PROGRAM

(71) Applicant: Sony Corporation, Tokyo (JP)

(72) Inventor: Naoki Yoshimochi, Kanagawa (JP)

(21) Appl. No.: 14/405,053

(22) PCT Filed: Jun. 27, 2013
(86) PCT No.: PCT/JP2013/067703

§ 371 Date: Dec. 2, 2014

(30) Foreign Application Priority Data
Jul. 6, 2012 (JP) 2012-152215

(51) Int. Cl. H04N 21/61; H04N 21/434; H04N 21/438; H04N 21/43

(52) U.S. Cl. CPC H04N 21/6112; H04N 21/4302; H04N 21/4348; H04N 21/4342; H04N 21/4382

(57) ABSTRACT

The present technique relates to a reception apparatus, method, and program which make it possible to promptly perform reception and demodulation of an intended profile at a low cost and with superior noise resistance in a broadcast signal of DVB-T2 in which various profiles are mixed.

An information extraction unit configured to extract, in a broadcast signal which meets a DVB-T2 standard and in which a plurality of profiles is mixed, information included in a frame corresponding to each of the plurality of profiles, and an operation control unit configured to control an operation of the information extraction unit in such a manner that information which is included in a frame of a first profile and which is necessary for processing related to frame synchronization and information which is included in a frame of a second profile and which is necessary for the processing related to the frame synchronization are constantly acquired among the plurality of profiles are included, the first profile being a profile for outputting data on which error-correction decoding is performed, and the second profile being a profile for not outputting data on which the error-correction decoding is performed.

### TECHNICAL FIELD

The present technique relates to a reception apparatus, method, and program and specifically relates to a reception apparatus, method, and program which make it possible to promptly perform reception and demodulation of an intended profile at a low cost and with superior noise resistance in a broadcast signal of DVB-T2 in which various profiles are mixed.

### BACKGROUND ART

As a standard of digital terrestrial broadcasting, for example, a second-generation European digital terrestrial broadcasting standard (DVB-T2 standard) has been developed (see Non-Patent Document 1).

In the digital terrestrial broadcasting which meets the DVB-T2 standard, a modulation method called an orthogonal frequency division multiplexing (OFDM) method is used.

Data transmission by the OFDM method is performed by using a plurality of orthogonal subcarriers in a transmission band and by assigning data to amplitude or a phase of each subcarrier. The data is transmitted in a symbol unit called an OFDM symbol. To the OFDM symbol, the inverse fast Fourier transform (IFFT) is performed during transmission.

In the DVB-T2 standard, a frame called a T2 frame is defined and data is transmitted in a unit of the T2 frame. Then, in the DVB-T2 standard, it is possible to multiplex a signal called a future extension frame (FEF) in a time direction and to transmit the multiplexed signal between transmission T2 frames.

The T2 frame includes a preamble signal called P1. The preamble signal includes information for determining whether the frame is the T2 frame or the FEF and information necessary for processing such as demodulation of an OFDM signal.

Also, in addition to P1, the T2 frame includes a preamble signal called P2. P2 includes information indicating a length, an interval, a type, and the like of the FEF and information necessary for demodulation processing of the T2 frame.

For example, in a reception apparatus, by acquiring information related to the FEF which information is included in each of P1 and P2, only the T2 frame can be extracted and demodulated. Thus, it is possible to eliminate an influence of the FEF and to improve demodulation performance.

In v1.3.1 of the DVB-T2 standard, profiles called T2-Base and T2-Lite are specified. T2-Base is a signal which meets a standard of and before v1.2.1 and is specified as a profile mainly for broadcasting to fixed reception. On the other hand, T2-Lite is added as a profile mainly for a mobile terminal. T2-Lite is a method in which a conventional T2 parameter is limited in order to reduce a receiver cost and is a method compatible with a conventional receiver.

It is specified that a profile of T2-Lite is transmitted as the FEF. Thus, in the future, in the digital terrestrial broadcasting which meets the DVB-T2 standard, a signal in which a profile of T2 and a profile of T2-Lite are mixed may be transmitted.

Also, a frame or an FEF of a different profile may be inserted between frames of each profile but the maximum length thereof is specified by the DVB-T2 standard. Up to 250 ms of a frame or an FEF of a different profile in total is transmitted between the T2-Base frame and the T2-Base frame. Up to one second of a frame or an FEF of a different profile in total is transmitted between the T2-Lite frame and the T2-Lite frame.

A receiver needs to select, from such a broadcast signal, a frame corresponding to a profile of T2-Base or T2-Lite, to demodulate the selected frame, and to extract a broadcast service included in the broadcast signal. In the receiver, by analyzing signaling of P1, a frame of an intended profile can be selected and a frame other than the intended profile is ignored.

### CITATION LIST

### Non-Patent Document

Non-Patent Document 1: DVB BlueBook A122 Rev.1, Frame structure channel coding and modulation for a second generation digital terrestrial television broadcasting system (DVB-T2) (2008). DVB-Digital Video Broadcasting <http://www.dvb.org/technology/>. Retrieved Jun. 8, 2012.

### SUMMARY OF THE INVENTION

### Problems to be Solved by the Invention

However, when a period of time in which a frame other than that of an intended profile is transmitted is long, a frequency error is generated or a timing error is gradually increased while the frame other than that of the intended profile is ignored.

That is, while the ignored frame is received, processing related to frequency synchronization and timing synchronization is not performed. Thus, a deviation (frequency error) between a frequency of a carrier, which is used for calculation of the FFT in demodulation of an OFDM signal, and a center frequency of the received OFDM signal and a deviation (timing error) between a clock signal generated in an inner part of a receiver and a clock in the received OFDM signal are accumulated.

As a result, when reception of a frame of the intended profile is resumed, there is a case where the frequency synchronization, the timing synchronization, and the like take a long period of time and a reception state is deteriorated until an error becomes small.

Also, when a frame other than that of the intended profile is ignored, demodulation is performed in a state in which temporally-successive OFDM signals are missing in a case where the demodulation is performed in the receiver. Thus, it becomes impossible to perform prediction-type channel estimation to predict a scattered pilot signal (SP signal) to be received by using the already-received SP signal and to estimate a transmission line characteristic thereafter in terms of time.

For example, interpolation-type channel estimation can be employed. However, in this case, a memory or the like to store a great number of symbols becomes necessary and noise resistance is deteriorated.

Thus, in a broadcast signal which meets the DVB-T2 standard, in a case where a plurality of profiles is mixed, there has been a problem that it takes a long period of time until a good reception state is acquired or that there is restriction in a channel estimation method in a conventional reception method.

The present technique is disclosed in view of the forgoing circumstance and is to make it possible to promptly perform reception and demodulation of an intended profile at a low cost and with superior noise resistance in a broadcast signal of DVB-T2 in which various profiles are mixed.

### Solutions to Problems

An aspect of the present technique is a reception apparatus including: an information extraction unit configured to extract, in a broadcast signal which meets a DVB-T2 standard and in which a plurality of profiles is mixed, information included in a frame corresponding to each of the plurality of profiles; and an operation control unit configured to control an operation of the information extraction unit in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.

The information which is included in the frame of the second profile and which is necessary for the processing related to the frame synchronization can be a P1 preamble signal.

The information which is included in the frame of the second profile and which is necessary for the processing related to the frame synchronization can be a scattered pilot signal or a continual pilot signal.

Frequency synchronization in the frame of the first profile can be performed based on the information which is included in the frame of the first profile and which is necessary for the processing related to the frame synchronization and the information which is included in the frame of the second profile and which is necessary for the processing related to the frame synchronization, the information being extracted by the information extraction unit.

Timing synchronization in the frame of the first profile can be performed based on the information which is included in the frame of the first profile and which is necessary for the processing related to the frame synchronization and the information which is included in the frame of the second profile and which is necessary for the processing related to the frame synchronization, the information being extracted by the information extraction unit.

Channel estimation in the frame of the first profile can be performed based on the information which is included in the frame of the first profile and which is necessary for the processing related to the frame synchronization and the information which is included in the frame of the second profile and which is necessary for the processing related to the frame synchronization, the information being extracted by the information extraction unit.

It is possible to extract a scattered pilot signal as the information which is included in the frame of the second profile and which is necessary for the processing related to the frame synchronization, to predict a scattered pilot signal of the frame of the first profile based on the scattered pilot signal extracted from the frame of the second profile, and to perform channel estimation in the frame of the first profile based on the predicted scattered pilot signal.

An aspect of the present technique is a reception method including: extracting, in a broadcast signal which meets a DVB-T2 standard and in which a plurality of profiles is mixed, information included in a frame corresponding to each of the plurality of profiles, the extracting being performed by an information extraction unit; and controlling an operation of the information extraction unit, which is performed by an operation control unit, in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.

An aspect of the present technique is a non-transitory computer-readable recording medium storing a program for causing a computer to function as a reception apparatus including: an information extraction unit configured to extract, in a broadcast signal which meets a DVB-T2 standard and in which a plurality of profiles is mixed, information included in a frame corresponding to each of the plurality of profiles; and an operation control unit configured to control an operation of the information extraction unit in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.

In an aspect of the present technique, information included in a frame corresponding to each of the plurality of profiles is extracted and an operation of the information extraction unit is controlled in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.

### Effects of the Invention

According to the present technique, it becomes possible to promptly perform reception and demodulation of an intended profile at a low cost and with superior noise resistance in a broadcast signal of DVB-T2 in which various profiles are mixed.

### BRIEF DESCRIPTION OF DRAWINGS

FIG. 1 is a view illustrating a configuration example of a broadcast signal specified in a DVB-T2 standard.

FIG. 2 is a view for describing S1 and S2 included in P1.

FIG. 3 is a view for describing a combination pattern of information in S1 and S2.

FIG. 4 is a view for describing signaling of L1 PRE.

FIG. 5 is a view for describing signaling of L1 POST.

FIG. 6 is a view for describing a combination of profiles of a broadcast signal which meets the DVB-T2 standard.

FIG. 7 is a view for describing an example of when a plurality of profiles are mixed.

FIG. 8 is a block diagram illustrating a configuration example of a conventional reception apparatus.

FIG. 9 is a view for describing an example of channel estimation in a case where only a frame of a profile of T2-Base is transmitted.

FIG. 10 is a view for describing an example of an operation of a conventional reception apparatus.

FIG. 11 is a view for describing an example of an operation of a reception apparatus to which the present technique is applied.

FIG. 12 is a view for describing an example of channel estimation in a case where T2-Lite is an intended profile and T2-Base is a pseudo FEF.

FIG. 13 is a view for describing a different example of an operation of the reception apparatus to which the present technique is applied.

FIG. 14 is a view for describing a different example of the channel estimation in the case where T2-Lite is an intended profile and T2-Base is a pseudo FEF.

FIG. 15 is a block diagram illustrating a configuration example of the reception apparatus to which the present technique is applied.

FIG. 16 is a flowchart for describing an example of reception processing for each profile.

FIG. 17 is a flowchart for describing a different example of the reception processing for each profile.

FIG. 18 is a block diagram illustrating a configuration example of a personal computer.

### MODE FOR CARRYING OUT THE INVENTION

In the following, an embodiment of the technique disclosed herein will be described with reference to the drawings.

First, a broadcast signal specified in the second-generation European digital terrestrial broadcasting standard (DVB-T2 standard) will be described.

In digital terrestrial broadcasting which meets the DVB-T2 standard, a modulation method called an orthogonal frequency division multiplexing (OFDM) method is used.

Data transmission by the OFDM method is performed by using a plurality of orthogonal subcarriers in a transmission band and by assigning data to amplitude or a phase of each subcarrier. The data is transmitted in a symbol unit called an OFDM symbol. To the OFDM symbol, the inverse fast Fourier transform (IFFT) is performed during transmission.

In the DVB-T2 standard, a frame called a T2 frame is defined and data is transmitted in a unit of the T2 frame. Then, in the DVB-T2 standard, it is possible to multiplex a signal called a future extension frame (FEF) in a time direction and to transmit the multiplexed signal between transmission T2 frames.

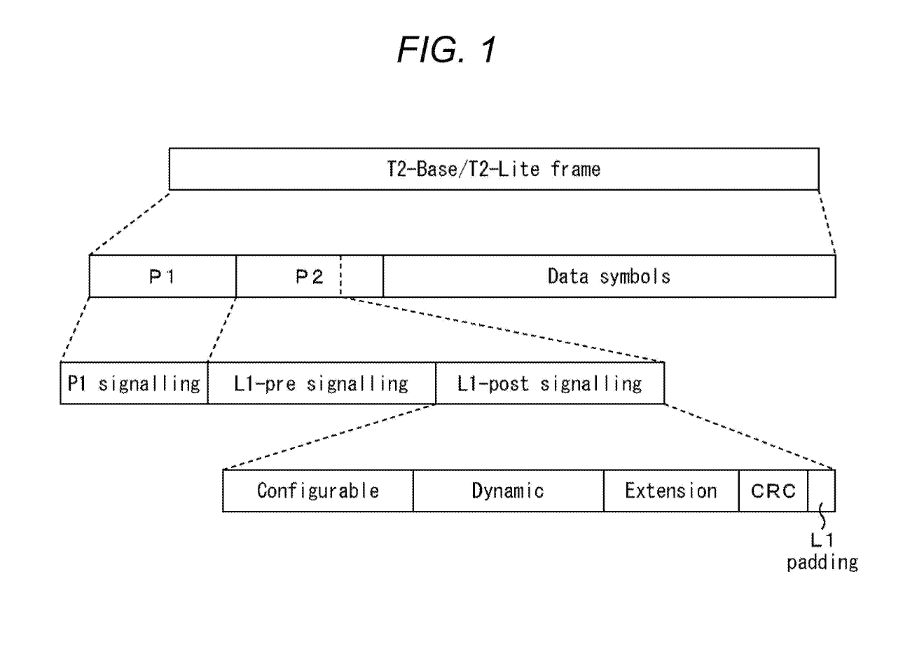

FIG. 1 is a view for describing a configuration of a T2 frame. As illustrated in FIG. 1, the T2 frame includes a P1 symbol, a P2 symbol, and a data symbol. Each of the P1 symbol and the P2 symbol is referred to as a preamble signal.

In P1 which is a preamble signal, signaling of determination information to determine whether the frame is a T2 frame or is an FEF is performed. Thus, a reception apparatus to receive the T2 frame and a reception apparatus to receive an FEF can respectively extract and demodulate the T2 frame and the FEF by acquiring information included in P1.

Also, in a case where the frame is the T2 frame, signaling of information necessary for demodulation processing such as an FFT size (number of samples (symbol) to be object of one FFT calculation) of when FFT calculation of a symbol other than P1 is performed is further performed in P1. That is, when the frame is the T2 frame, it is necessary to demodulate P1 in order to demodulate P2 since P1 includes a transmission method, an FFT size, and the like necessary for demodulation of P2.

Signaling of P1 is configured by parts called S1 and S2. S1 is configured in three bits and S2 is configured in four bits.

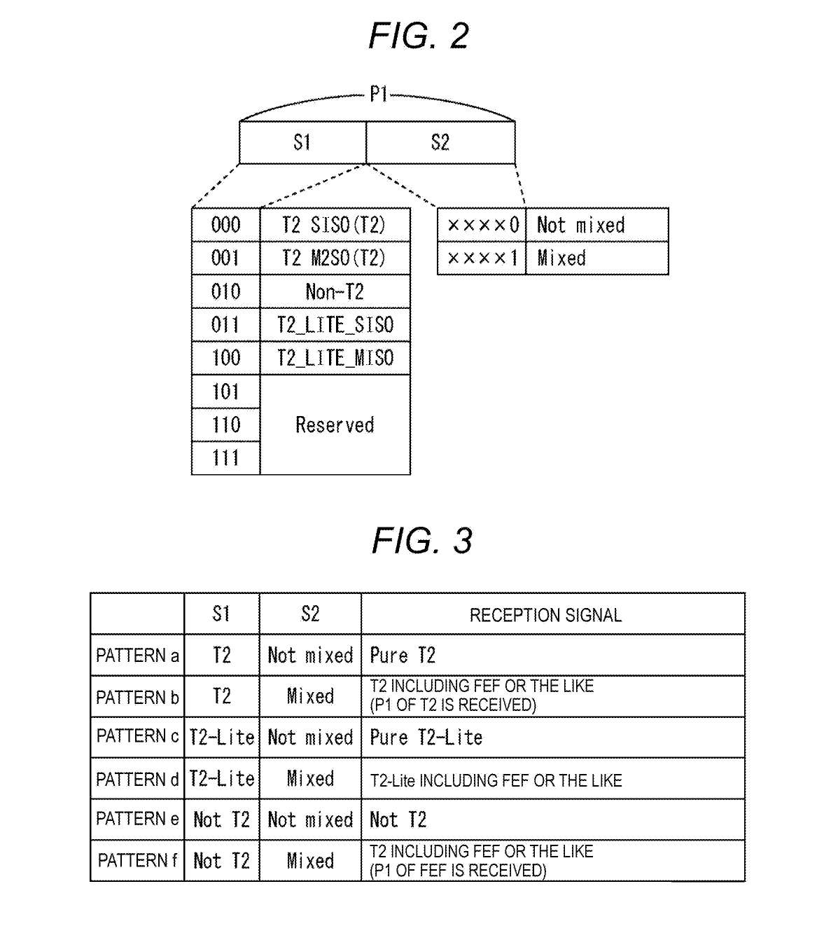

S1 and S2 included in P1 will be described with reference to FIG. 2. As described above, P1 is configured by S1 and S2 in seven bits.

Since S1 is configured in three bits, a value thereof may be “000”, “001”, “010”, “011”, “100”, “101”, “110”, or “111”.

In a case where S1 is “000”, it is indicated that the frame is T2 single input single output (SISO) and is the T2 frame. In a case where S1 is “001”, it is indicated that the frame is T2 multiple input single output (MISO) and is the T2 frame. In a case where S1 is “010”, it is indicated that the frame is the FEF. In a case where S1 is “011”, it is indicated that the frame is T2-Lite SISO and is a T2-Lite frame which will be described later. In a case where S1 is “100”, it is indicated that the frame is T2-Lite MISO and is the T2-Lite frame which will be described later. In a case where S1 is “101”, “110”, or “111”, these are values usage of which is not defined since these values are reserved. In a case where S1 is one of these values, it can be at least recognized, on a reception apparatus side, that the frame is not the T2 frame.

For example, in a case where there is a possibility that a signal in which the T2 frame and the FEF are multiplexed is received, when S1 included in P1 is “000” or “001”, it can be understood that the frame is the T2 frame and when S1 is a value other than these values, it can be understood that the frame is the T2-Lite frame or the FEF, by interpreting S1, on the reception apparatus side.

S2 included in P1 is configured in four bits. In FIG. 2, among the four bits, three bits other than a least significant bit (LSB) are illustrated as×since values indicating a FET SIZE are described therein. In a case where the LSB of S2 is “0”, it is indicated that the received signal is “Not Mixed”. “Not Mixed” indicates a case where a frame of a different profile is not mixed and where there is no FEF.

In a case where the LSB of S2 is “1”, it is indicated that the received signal is “Mixed”. “Mixed” indicates a case where a frame of a different profile is mixed or where there is the FEF.

Such information is included in each of S1 and S2. Thus, as combinations of information in S1 and S2, there are patterns illustrated in FIG. 3. With each of the patterns, it is possible to specify what kind of signal (frame) the received signal is.

A pattern a is a pattern with which it can be understood that the received signal is the T2 frame since S1 is “000” or “001” and that no different frame is included (Not Mixed) in the received signal since S2 is “xxx0”. In a case of the pattern a, the received signal is a signal (Pure T2) in which only the T2 frame is included. The reception apparatus performs processing suitable for the pattern a.

A pattern b is a pattern with which it can be understood that the received signal is the T2 frame since S1 is “000” or “001” and that a different frame is included (Mixed) in the received signal since S2 is “xxx1”. Also, in such a state, it can be also understood that a frame to be processed is the T2 frame and that P1 included in the T2 frame is processed. In a case of such a pattern b, the received signal is a signal including the T2 frame and the T2-Lite frame (or FEF frame). The reception apparatus performs processing suitable for the pattern b.

A pattern c is a pattern with which it can be understood that the received signal is the T2-Lite frame since S1 is “011” or “100” and that no different frame is included (Not Mixed) in the received signal since S2 is “xxx0” . In a case of the pattern c, the received signal is a signal (Pure T2-Lite) in which only the T2-Lite frame is included. The reception apparatus performs processing suitable for the pattern c.

A pattern d is a pattern with which it can be understood that the received signal is the T2-Lite frame since S1 is “011” or “100” and that a different frame is included (Mixed) in the received signal since S2 is “xxx1”. Also, in such a state, it can be also understood that a frame to be processed is the T2-Lite frame and that P1 included in the T2-Lite frame is processed. In a case of such a pattern b, the received signal is a signal including the T2-Lite frame and the T2 frame (or FEF frame). The reception apparatus performs processing suitable for the pattern d.

A pattern e is a pattern with which it can be understood that the received signal is the FEF frame since S1 is “010” and that no different frame is included (Not Mixed) in the received signal since S2 is “xxx0”. In a case of the pattern e, since the received signal is a signal in which only the FEF is included, the reception apparatus performs processing suitable for the pattern e.

A pattern f is a state in which it can be understood that the received signal is other than the T2 frame and the T2-Lite frame since S1 is “101”, “110”, or “111” and that a different frame is included (Mixed) in the received signal since S2 is “xxx1”. Also, in such a state, it can be also understood that a frame to be processed is the FEF and that P1 included in the FEF is processed.

In such a manner, it is possible to understand a characteristic (pattern a to pattern d) of a reception signal by decrypting P1 which is the preamble signal included in the T2 frame and the FEF.

Also, on P2 which is a preamble signal, signaling of L1 PRE and L1 POST is performed.

L1 PRE includes information necessary for decoding of L1 POST performed by the reception apparatus to receive the T2 frame. L1 POST includes information necessary for accessing (layer pipes of) a physical layer performed by the reception apparatus.

Incidentally, L1 PRE includes, for example, a GI length, a pilot pattern (PILOT_PATTERN) which indicates an arrangement of a pilot signal, which is an already-known signal, and indicates which symbol (subcarrier) includes the pilot signal, existence/nonexistence (BWT_EXT) of extension in a transmission band in which an OFDM signal is transmitted, and the number of OFDM symbols (NUM_DATA_SYMBOLS) included in one T2 frame. These are pieces of information necessary for demodulation of a symbol of data.

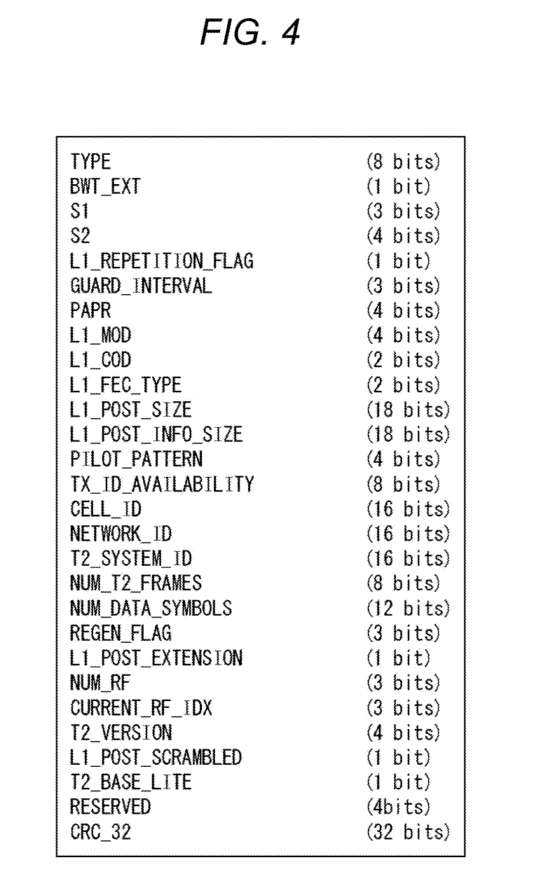

FIG. 4 is a view for describing signaling of L1 PRE. As illustrated in FIG. 4, signaling of various information is performed in each bit.

L1 POST includes information indicating a length, an interval, a type, and the like of the FEF and information necessary for demodulation processing of the T2 frame.

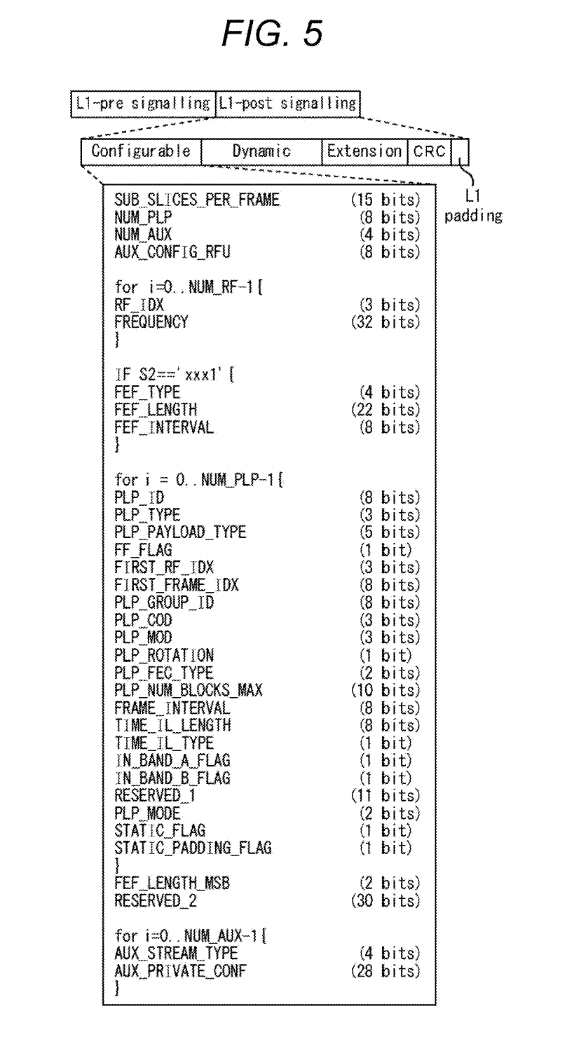

FIG. 5 is a view for describing signaling of L1 POST. For example, based on “FEF_LENGTH” and “FEF_LENGTH MSB” illustrated in FIG. 5, a total length of the FEF of when seen from the intended profile and the T2 frame which is not the intended profile can be understood.

In the reception apparatus to receive the T2 frame, it becomes possible to demodulate a symbol of data after information signaling of which is performed in L1 PRE and L1 POST is acquired. Also, in the reception apparatus to receive the T2 frame, by acquiring information of the FEF which information is included in P1 and P2, it is possible to extract and demodulate the T2 frame. Thus, it is possible to eliminate an influence from the FEF and to improve demodulation performance.

Incidentally, in v1.3.1 of the DVB-T2 standard, profiles called T2-Base and T2-Lite are specified. T2-Base is a signal which meets a standard of and before v1.2.1 and is specified as a profile mainly for broadcasting to fixed reception. On the other hand, T2-Lite is added as a profile mainly for a mobile terminal. T2-Lite is a method in which a conventional T2 parameter is limited in order to reduce a cost of a reception apparatus and is a method compatible with a conventional reception apparatus.

It is specified that a profile of T2-Lite is transmitted as the FEF. Thus, in the future, in the digital terrestrial broadcasting which meets the DVB-T2 standard, a signal in which a profile of T2 and a profile of T2-Lite are mixed may be transmitted.

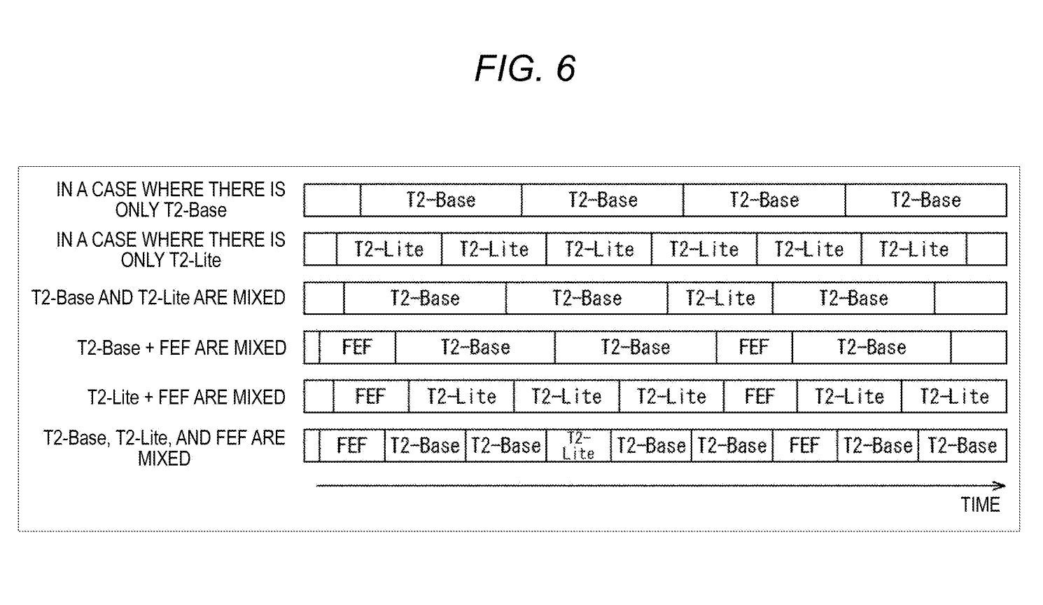

FIG. 6 is a view for describing a combination of profiles of a broadcast signal of the digital terrestrial broadcasting which meets v1.3.1 of the DVB-T2 standard.

The top in FIG. 6 is a part illustrating an example of a broadcast signal including only a T2-Base frame. The second from the top in the drawing is a part illustrating an example of a broadcast signal including only a T2-Lite frame. The third from the top in the drawing is a part illustrating an example of a broadcast signal including a T2-Base frame and a T2-Lite frame. The fourth from the top in the drawing is a part illustrating an example of a broadcast signal including a T2-Base frame and an FEF in a case where there are a great number of the T2-Base frames. The fifth from the top (second from bottom) in the drawing is a part illustrating an example of a broadcast signal including a T2-Lite frame and an FEF in a case where there are a great number of the T2-Lite frames. The bottom in the drawing is a part illustrating an example of a broadcast signal including a T2-Base frame, a T2-Lite frame, and an FEF.

Note that each small rectangle in the drawing indicates a frame of the broadcast signal which meets the DVB-T2 standard.

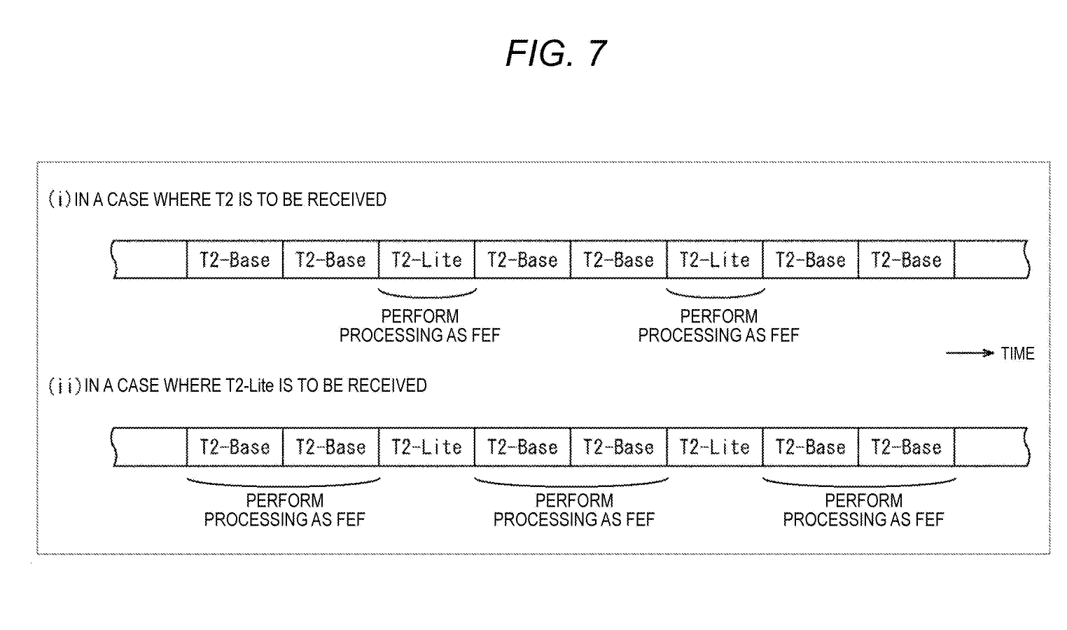

For example, as illustrated in an upper side of FIG. 7, in a case where the T2-Base frame and the T2-Lite frame are mixed, a reception apparatus to receive and demodulate a profile of T2 and to output decoded data performs processing on the assumption that the T2-Lite frame is the FEF. Also, for example, as illustrated in a lower side of FIG. 7, a reception apparatus to receive and demodulate a profile of T2-Lite and to output decoded data performs processing on the assumption that the T2-Base frame is the FEF. A frame of a profile assumed as the FEF in such a manner is referred to as a pseudo FEF.

According to specification of the DVB-T2 standard, in a case where the T2-Base frame and the T2-Lite frame are mixed, in the reception apparatus, a length of the pseudo FEF is acquired by analyzing L1 POST signaling of the T2-Lite frame. Thus, when P1 of the T2-Base frame is detected, it is not necessary for the reception apparatus to perform detection of P1 until next arrival of P1 of the T2-Lite frame.

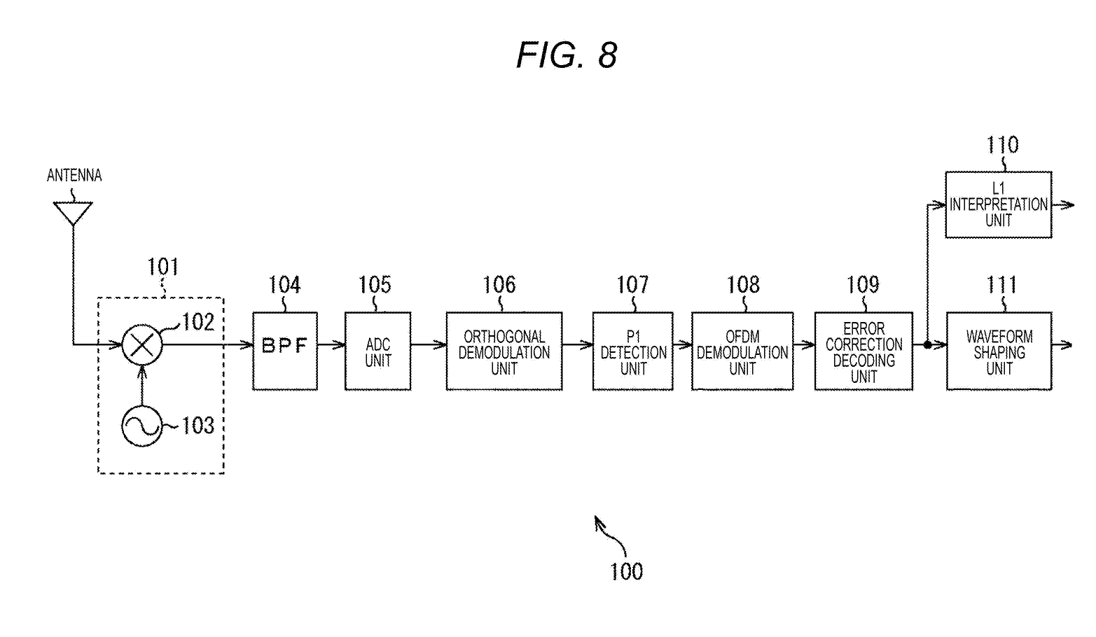

FIG. 8 is a block diagram illustrating a configuration example of a conventional reception apparatus to receive and demodulate a broadcast signal which meets the DVB-T2 standard.

A reception apparatus 100 illustrated in FIG. 8 includes a tuner 101, a bandpass filter (BPF) 104, an analogue-to-digital converter (ADC) unit 105, an orthogonal demodulation unit 106, a P1 detection unit 107, an OFDM demodulation unit 108, an error-correction decoding unit 109, an L1 interpretation unit 110, and a waveform shaping unit 111.

A broadcast wave broadcasted from the broadcast station is received through an antenna of the reception apparatus 100 and is supplied as an RF signal to the tuner 101.

The tuner 101 includes a multiplication circuit 102 and a local oscillator 103 and converts the received RF signal into OFDM signal (IF signal) having an intermediate frequency.

After being filtered by the BPF 104, the IF signal output from the tuner 101 is converted into a digital signal by the ADC unit 105.

The digital signal output from the ADC unit 105 is supplied to the orthogonal demodulation unit 106. The orthogonal demodulation unit 106 performs orthogonal demodulation of the digitalized IF signal by using a carrier signal having a predetermined frequency (ideally, carrier frequency) and outputs an OFDM signal in a baseband. Here, the OFDM signal output from the orthogonal demodulation unit 106 is a signal in a time domain before the FFT calculation is performed (immediately after inverse FFT (IFFT) calculation of transmission symbol (data transmitted by one subcarrier) on IQ constellation is performed on transmission apparatus side) and is also referred to as an OFDM time domain signal.

The P1 detection unit 107 detects P1 from the OFDM signal in the baseband which signal is output from the orthogonal demodulation unit 106. Also, the P1 detection unit 107 determines a profile of the T2 frame acquired from the received broadcast signal, analyzes P1 signaling, and detects a start position of the T2 frame.

Moreover, during the detection of P1 performed by the P1 detection unit 107, frequency synchronization and timing synchronization can be performed. Details of the frequency synchronization and the timing synchronization are disclosed, for example, in “DVB-T2 Implementation Guideline DVB Document A133”.

In an OFDM demodulation unit 208, the FFT calculation and equalization processing are performed. Here, by using a pilot signal, the frequency synchronization and the timing synchronization are performed. Channel estimation is also performed. Note that for the frequency synchronization and the timing synchronization, a continual pilot signal is used. For the channel estimation, a scattered pilot signal is used.

In the FFT calculation, an (sample value of) OFDM time domain signal in an FFT interval is extracted from the OFDM time domain signal according to a symbol synchronization signal and the fast Fourier transform (FFT) calculation which is high-speed calculation of discrete Fourier transform (DFT) is performed. An OFDM signal acquired by the FFT calculation of the OFDM time domain signal is a signal in a frequency domain and is also referred to as an OFDM frequency domain signal. Here, a deviation between a frequency of a subcarrier used for the FFT calculation and a frequency of a subcarrier of the OFDM signal transmitted from the transmission apparatus is detected as a frequency error based on the continual pilot signal.

For example, by using a difference in power between the continual pilot signal and the data, correlation of the subcarriers is calculated and a carrier shift is detected as a frequency error.

By correcting the frequency error, the frequency synchronization and the timing synchronization are performed. In such a manner, it becomes possible to correct an error which is not eliminated in the frequency synchronization and the timing synchronization performed during the detection of P1.

Also, since the timing synchronization and the frequency synchronization are performed, it becomes possible to demodulate a frame of a predetermined profile appropriately. Thus, it can be said that the timing synchronization and the frequency synchronization performed in the OFDM demodulation unit 208 are processing related to frame synchronization.

In the equalization processing, a scattered pilot signal (SP signal) inserted in the OFDM frequency domain signal is detected. Then, from the SP signal, channel estimation processing to estimate a transmission line characteristic, which is a frequency characteristic of a transmission line in which the OFDM signal is transmitted, is performed. Here, by dividing the OFDM frequency domain signal by an estimation value of the transmission line characteristic, distortion correction to correct distortion which the OFDM signal receives in the transmission line is performed as the equalization processing. The OFDM frequency domain signal after the distortion correction is supplied to the error-correction decoding unit 109.

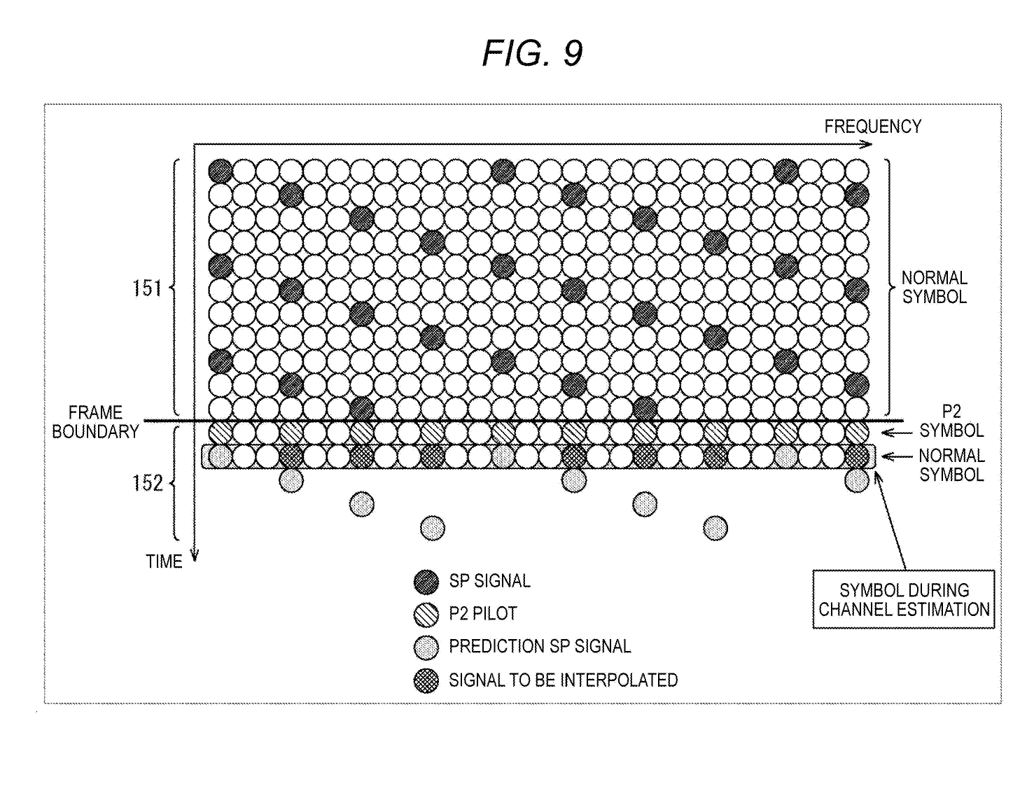

FIG. 9 is a view for describing channel estimation in a case where only a frame of a profile of T2-Base is transmitted. In an example in FIG. 9, prediction-type channel estimation is performed.

In FIG. 9, two frames of a profile of T2-Base are illustrated with a horizontal axis as a frequency (subcarrier number) and a vertical axis as time. Each circle in the drawing indicates a signal demodulated into each subcarrier.

In this case, a T2-Base frame 151 is a frame which is already received by the reception apparatus and a T2-Base frame 152 is a frame to be received after elimination of a P2 symbol at a head of the frame.

Note that in this example, there is only one line (one clock) of the P2 symbol at a head position of the frame. At a frequency corresponding to a subcarrier number identical to each SP signal, a P2 pilot signal is included. A symbol in each line which symbol is received subsequently after the P2 symbol is referred to as a normal symbol.

An SP signal in the T2-Base frame 152 is a prediction SP signal which is predicted based on an SP signal included in the T2-Base frame 151.

A signal to be interpolated in the T2-Base frame 152 is a signal interpolated based on the P2 pilot signal of the P2 symbol and the prediction SP signal. In such a manner, a signal other than the pilot signal of the normal symbol is interpolated based on the P2 pilot signal and the prediction SP signal, and thus, distortion correction is performed.

When prediction-type channel estimation illustrated in FIG. 9 is performed, the reception apparatus only needs to store the SP signal in the T2-Base frame 151, and thus, memory capacity is controlled. Also, when the prediction-type channel estimation is performed, it is possible to perform channel estimation with super noise resistance since channel estimation using a plurality of pilot signals is performed.

Referring back to FIG. 8, the error-correction decoding unit 109 is configured to perform decoding of a signal on which error-correction coding is performed. In the error-correction decoding unit 109, L1 and data are decoded and L1 is supplied to an L1 analyzing unit 110 and the data is supplied to the waveform shaping unit 111.

The L1 analyzing unit 110 acquires, from L1, a parameter signaling of which is performed on a transmission side.

The waveform shaping unit 111 outputs only an intended signal in an appropriate waveform format.

Incidentally, in a case where the T2-Base frame and the T2-Lite frame are mixed, it is necessary for the reception apparatus to extract a broadcast service included in such a broadcast signal by selecting a frame corresponding to a profile of T2-Base or T2-Lite from the broadcast signal and demodulating the selected frame.

According to the specification of the DVB-T2 standard, in the reception apparatus, a frame of the intended profile can be selected by analyzing signaling of P1 and the pseudo FEF is ignored.

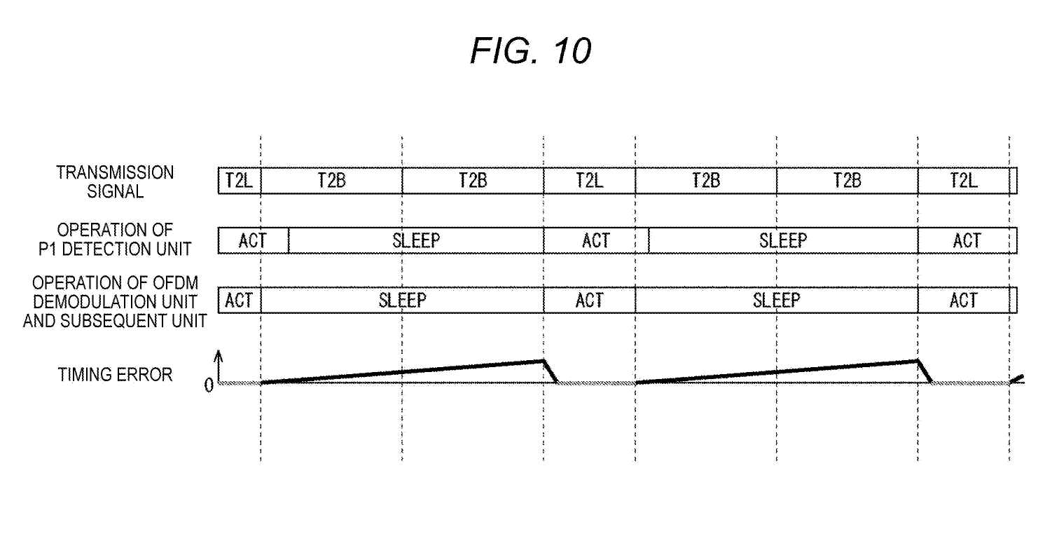

For example, a case where T2-Lite is the intended profile and T2-Base is the pseudo FEF will be considered. FIG. 10 is a view for describing an example of an operation of a conventional reception apparatus 100 in this case. In FIG. 10, a profile of a frame in a transmission signal, an operation state of the P1 detection unit 107, an operation state of the OFDM demodulation unit and subsequent units, and an accumulation state of a timing error are illustrated with a horizontal axis as time. Note that here, the OFDM demodulation unit and the subsequent units indicate the OFDM demodulation unit 108, the error-correction decoding unit 109, the L1 interpretation unit 110, and the waveform shaping unit 111.

In an example in FIG. 10, in the transmission signal, the T2-Base frame (T2B) and the T2-Lite frame (T2L) are mixed and one T2-Lite frame is periodically transmitted to two T2-Base frames.

Also, in the example in FIG. 10, the P1 detection unit 107 operates (“ACT”) in a time corresponding to a left end part in the drawing of the T2-Lite frame among the T2-Lite frame and the two T2-Base frames, and is paused (“SLEEP”) for the rest.

Note that as described above, in a case where the T2-Base frame and the T2-Lite frame are mixed, in the reception apparatus, a length of the pseudo FEF (two successive T2-Base frame in this case) is acquired by analyzing L1 POST signaling of the T2-Lite frame. Thus, when P1 of one of the successive T2-Base frames is detected, it is not necessary for the reception apparatus to perform detection of P1 of the rest of the T2-Base frames.

Moreover in the example in FIG. 10, the OFDM demodulation unit and the subsequent units operate (“ACT”) in a time corresponding to the T2-Lite frame and is paused (“SLEEP”) in a time corresponding to the T2-Base frame.

Also, in the example in FIG. 10, a timing error is gradually increased from the time corresponding to a left end part in the drawing of a T2-Base frame on a left side in the drawing between the two successive T2-Base frames and is increased until the time corresponding to a right end part in the drawing of a T2-Base frame on a right side in the drawing. Then, the timing error is decreased precipitously at a position corresponding to the left end part in the drawing of the T2-Lite frame and becomes zero. As described above, it is because the timing synchronization is performed along with the detection of P1 by the P1 detection unit 107.

Note that frame synchronization is performed by an operation of the OFDM demodulation unit and the subsequent units in a time corresponding to the T2-Lite frame. Thus, an error which is not eliminated in the frequency synchronization and the timing synchronization performed during the detection of P1 is corrected. Thus, in the example in FIG. 10, a timing error is not accumulated and becomes stable substantially at zero in the time corresponding to the T2-Lite frame.

As illustrated in FIG. 10, according to a reception method of a conventional reception apparatus, a deviation (timing error) between a clock signal generated in an inner part of the receiver and a clock in the received OFDM signal is accumulated. Also, although not illustrated in FIG. 10, there is a case where a deviation (frequency error) between a frequency of a subcarrier used for the FFT calculation and a frequency of a subcarrier of the OFDM signal transmitted from the transmission apparatus is generated. However, while the P1 detection unit 107 is paused, the frequency synchronization is not performed.

As a result, when reception of a frame (T2-Lite frame in this case) of the intended profile is resumed, there is a case where the frequency synchronization, the timing synchronization, and the like take a long period of time and a reception state is deteriorated until an error becomes small.

Thus, in the present technique, the P1 detection unit 107 is operated also in the pseudo FEF interval.

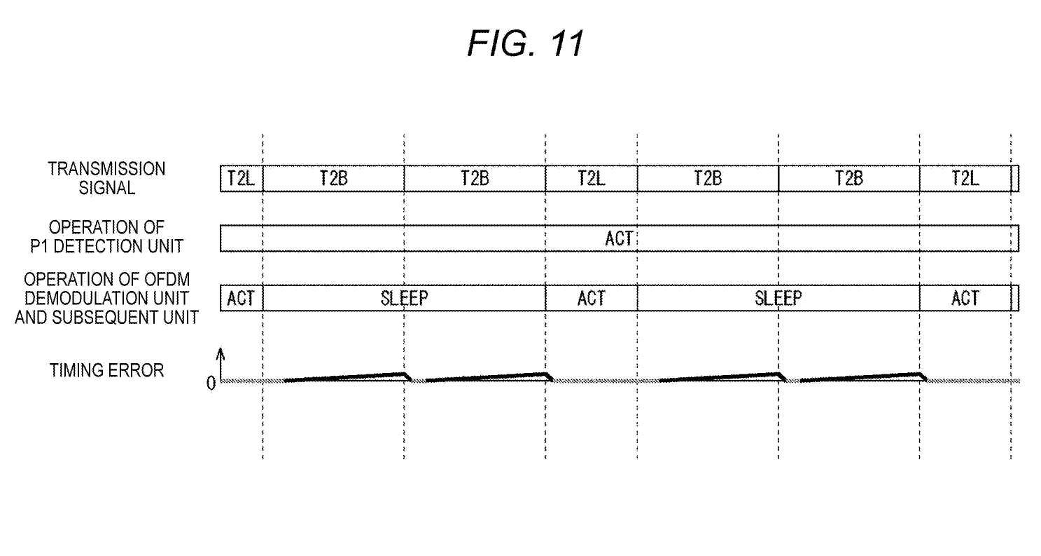

FIG. 11 is a view for describing an example of an operation of a reception apparatus 100 to which the present technique is applied in a case where T2-Lite is an intended profile and T2-Base is a pseudo FEF. Similarly to FIG. 10, in FIG. 11, a profile of a frame in a transmission signal, an operation state of a P1 detection unit 107, an operation state of an OFDM demodulation unit and subsequent units, and an accumulation state of a timing error are illustrated with a horizontal axis as time. Note that here, the OFDM demodulation unit and the subsequent units indicate an OFDM demodulation unit 108, an error-correction decoding unit 109, an L1 interpretation unit 110, and a waveform shaping unit 111.

In an example in FIG. 11, in the transmission signal, a T2-Base frame (T2B) and a T2-Lite frame (T2L) are mixed and one T2-Lite frame is periodically transmitted to two T2-Base frames.

Also, unlike the case of FIG. 10, the P1 detection unit 107 operates (“ACT”) in a time corresponding to all of the T2-Lite frame and the two T2-Base frames in the example in FIG. 11.

Moreover in the example in FIG. 11, the OFDM demodulation unit and the subsequent units operate (“ACT”) in a time corresponding to the T2-Lite frame and is paused (“SLEEP”) in a time corresponding to the T2-Base frame. It is similar to the case of FIG. 10.

Also, unlike the example in FIG. 10, a timing error is decreased precipitously at a position corresponding to a left end part in the drawing of the T2-Base frame and the T2-Lite frame and becomes zero in the example in FIG. 11. Note that for a time from the left end part to the right end part in the drawing of each T2-Base frame, the timing error is increased but is decreased precipitously at the time which is a boundary with a next frame. As described above, it is because timing synchronization is performed along with detection of P1 by the P1 detection unit 107.

Note that frame synchronization is performed by an operation of the OFDM demodulation unit and the subsequent units in a time corresponding to the T2-Lite frame. Thus, an error which is not eliminated in frequency synchronization and timing synchronization performed during the detection of P1 is corrected. Thus, in the example in FIG. 11, a timing error is not eliminated and becomes stable substantially at zero in the time corresponding to the T2-Lite frame.

As illustrated in FIG. 11, according to a reception method of the reception apparatus to which the present technique is applied, a deviation (timing error) between a clock signal generated in an inner part of the receiver and a clock in a received OFDM signal is rarely accumulated. Although, not illustrated in FIG. 11, even when a deviation (frequency error) between a frequency of a subcarrier used for the FFT calculation and a frequency of a subcarrier of the OFDM signal transmitted from the transmission apparatus is generated, frequency synchronization is performed at the time corresponding to a boundary of each frame and the deviation is corrected.

As a result, when reception of a frame (T2-Lite frame in this case) of the intended profile is resumed, it does not take a long period of time for the frequency synchronization, the timing synchronization, and the like and a reception state is not deteriorated.

Incidentally, in the example described with reference to FIG. 11, the OFDM demodulation unit and the subsequent units operates in a time corresponding to the T2-Lite frame and are paused in a time corresponding to the T2-Base frame.

In this case, it is not possible to perform prediction-type channel estimation described with reference to FIG. 9.

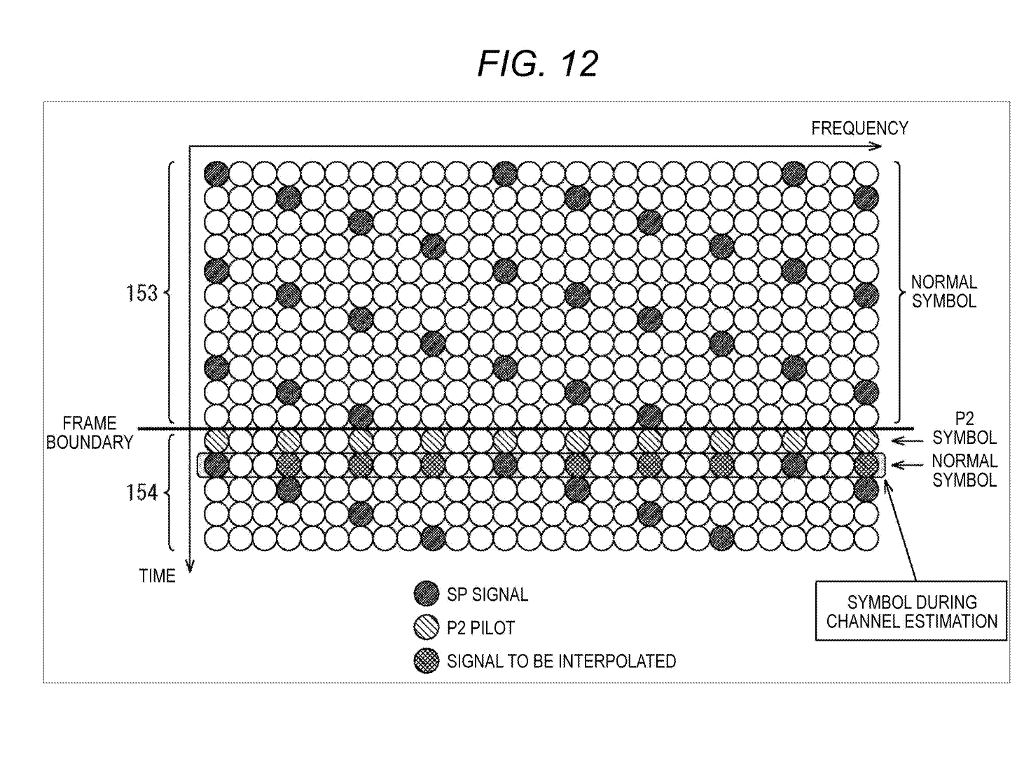

FIG. 12 is a view for describing channel estimation in a case where various profiles are mixed and where the T2-Lite is the intended profile and the T2-Base is the pseudo FEF. FIG. 12 is a view for describing channel estimation in a case where each unit of the reception apparatus 100 is operated by a reception method illustrated in FIG. 11.

In FIG. 12, a frame of the profile of the T2-Base and a frame of the profile of the T2-Lite are illustrated with a horizontal axis as a frequency (subcarrier number) and a vertical axis as time. Each circle in the drawing indicates a signal demodulated into each subcarrier.

In this case, a T2-Base frame 153 is a frame which is already received by the reception apparatus. In a case of FIG. 12, in order to interpolate a signal to be interpolated of a symbol during channel estimation in the drawing, it is necessary to store a signal of five symbols of a T2-Lite frame 154.

Note that in this example, there is only one line (one clock) of a P2 symbol at a head position of the frame. At a frequency corresponding to a subcarrier number identical to each SP signal, a P2 pilot signal is included. A symbol in each line which symbol is received subsequently after the P2 symbol is referred to as a normal symbol.

In the prediction-type channel estimation, as described with reference to FIG. 9, it is necessary to generate prediction SP by predicting an SP signal to be received based on an already-received SP signal of the T2-Base frame 153. However, when the OFDM demodulation unit and the subsequent units are paused in the time corresponding to the T2-Base frame, it is not possible to acquire the SP signal of the T2-Base frame 153. Thus, in an example in FIG. 12, it is necessary to interpolate a signal to be interpolated of a symbol during the channel estimation after a signal which is assumed as a prediction SP signal in FIG. 9 is actually received.

Thus, in a case of the example in FIG. 12, it is necessary to provide, in the reception apparatus 100, a memory to store at least a signal of five symbols of the T2-Lite frame 154. Also, even when such a memory is provided, no SP signal of the T2-Base frame 153 can be used for the channel estimation. Thus, noise resistance may be deteriorated.

Thus, it the present technique, the demodulation unit and the subsequent units may be operated in the pseudo FEF interval along with the P1 detection unit 107.

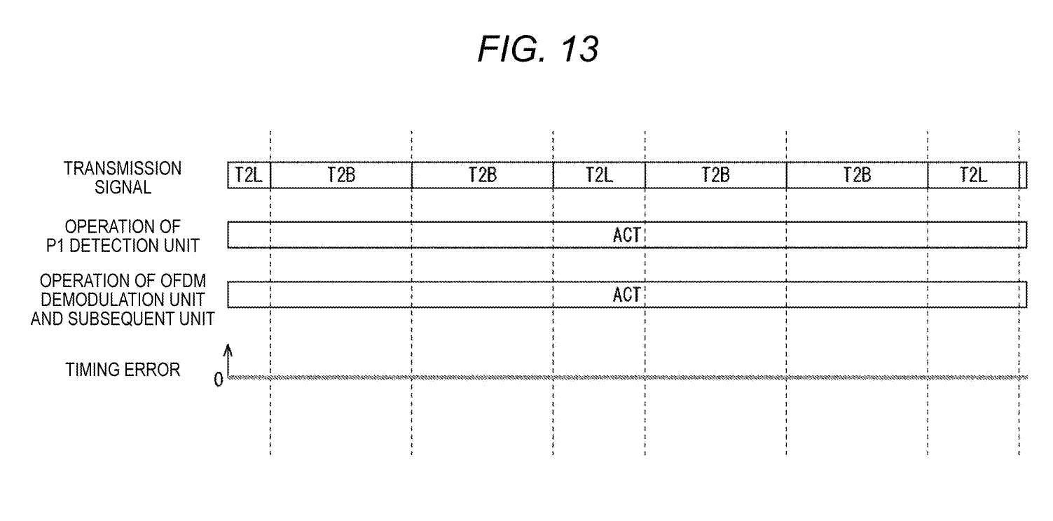

FIG. 13 is a view for describing a different example of an operation of the reception apparatus 100 to which the present technique is applied in a case where T2-Lite is the intended profile and T2-Base is the pseudo FEF. Similarly to FIG. 11, in FIG. 12, a profile of a frame in a transmission signal, an operation state of the P1 detection unit 107, an operation state of the OFDM demodulation unit and subsequent units, and an accumulation state of a timing error are illustrated with a horizontal axis as time. Note that here, the OFDM demodulation unit and the subsequent units indicate the OFDM demodulation unit 108, the error-correction decoding unit 109, the L1 interpretation unit 110, and the waveform shaping unit 111.

In an example in FIG. 13, in the transmission signal, the T2-Base frame (T2B) and the T2-Lite frame (T2L) are mixed and one T2-Lite frame is periodically transmitted to two T2-Base frames.

Also, similarly to the case of FIG. 11, in the example in FIG. 13, the P1 detection unit 107 operates (“ACT”) in a time corresponding to all of the T2-Lite frame and the two T2-Base frames.

Moreover, unlike the case of FIG. 11, in the example in FIG. 13, the demodulation unit and the subsequent units operate (“ACT”) in a time corresponding to all of the T2-Lite frame and the two T2-Base frames.

Also, unlike the case of FIG. 11, in the example in FIG. 13, a timing error is zero in a time corresponding to all of the T2-Lite frame and the two T2-Base frames. As described above, timing synchronization is performed along with detection of P1 by the P1 detection unit 107 and the OFDM demodulation unit and the subsequent units are operated, and thus, frame synchronization is performed. Accordingly, the timing error becomes stable substantially at zero.

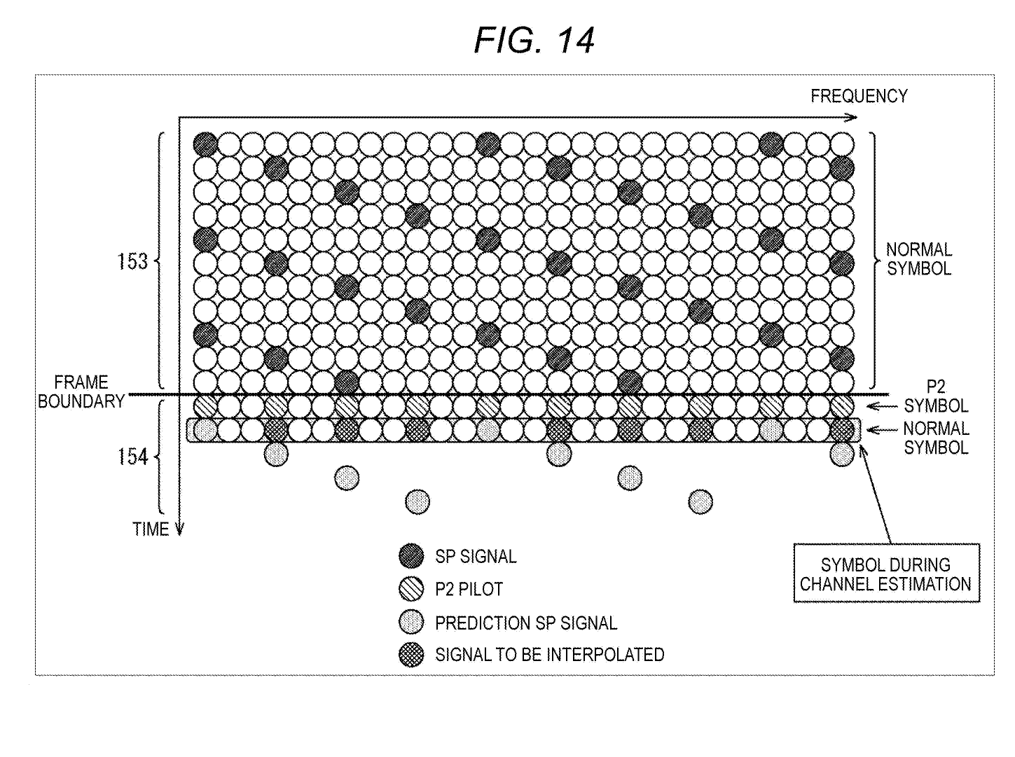

FIG. 14 is a view for describing a different example of channel estimation in a case where various profiles are mixed and where the T2-Lite is the intended profile and the T2-Base is the pseudo FEF. FIG. 14 is a view for describing channel estimation in a case where each unit of the reception apparatus 100 is operated in a reception method illustrated in FIG. 13.

In FIG. 14, a frame of the profile of the T2-Base and a frame of the profile of the T2-Lite are illustrated with a horizontal axis as a frequency (subcarrier number) and a vertical axis as time. Each circle in the drawing indicates a signal demodulated into each subcarrier.

In this case, a T2-Base frame 153 is a frame which is already received by the reception apparatus 100.

Note that in this example, there is only one line (one clock) of the P2 symbol at a head position of the frame. At a frequency corresponding to a subcarrier number identical to each SP signal, a P2 pilot signal is included. A symbol in each line which symbol is received subsequently after the P2 symbol is referred to as a normal symbol.

An SP signal in the T2-Lite frame 154 is a prediction SP signal predicted based on an SP signal included in the T2-Base frame 153.

A signal to be interpolated in the T2-Lite frame 154 is a signal interpolated based on the P2 pilot signal of the P2 symbol and the prediction SP signal. In such a manner, a signal other than the pilot signal of the normal symbol is interpolated based on the P2 pilot signal and the prediction SP signal, and thus, distortion correction is performed.

That is, by making the demodulation unit and the subsequent units operate in the pseudo FEF interval along with the P1 detection unit 107, it becomes possible to perform prediction-type channel estimation even when various profiles are mixed.

When prediction-type channel estimation illustrated in FIG. 14 is performed, the reception apparatus 100 only needs to store the SP signal in the T2-Base frame 153, and thus, memory capacity is controlled. Also, when the prediction-type channel estimation is performed, it is possible to perform channel estimation with super noise resistance since channel estimation using a plurality of pilot signals is performed.

Note that in the example in FIG. 14, in order to simplify the description, the description has been made on the assumption that a pilot pattern of the T2-Base frame 153 and that of the T2-Lite frame 154 are the same. For example, in a case where the pilot pattern of the T2-Base frame 153 and that of the T2-Lite frame 154 are different, prediction-type channel estimation is performed relative to the T2-Base frame 153 and data necessary for prediction-type channel estimation of the T2-Lite frame 154 is calculated by interpolation and thinning. Then, the prediction-type channel estimation is performed relative to the T2-Lite frame 154.

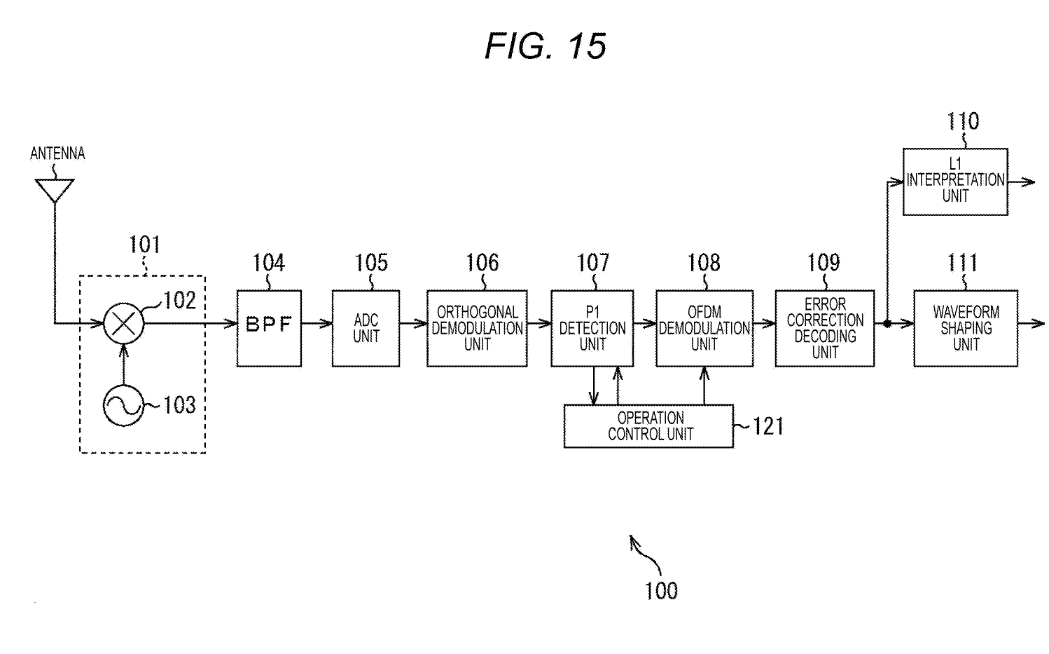

FIG. 15 is a block diagram illustrating a configuration example of an embodiment of a conventional reception apparatus to which the present technique is applied and which is to receive and demodulate a broadcast signal which meets the DVB-T2 standard. In FIG. 15, the same sign is assigned to a part corresponding to FIG. 8.

A reception apparatus 100 illustrated in FIG. 15 includes a tuner 101, a bandpass filter (BPF) 104, an analogue-to-digital converter (ADC) unit 105, an orthogonal demodulation unit 106, a P1 detection unit 107, an OFDM demodulation unit 108, an error-correction decoding unit 109, an L1 interpretation unit 110, a waveform shaping unit 111, and an operation control unit 121. That is, unlike the case of FIG. 8, the operation control unit 121 is provided in the configuration example in FIG. 15.

In a case of the configuration in FIG. 15, the P1 detection unit 107 detects P1 from an OFDM signal in a baseband which signal is output from the orthogonal demodulation unit 106. Also, the P1 detection unit 107 determines a profile of a T2 frame acquired from a received broadcast signal, analyzes P1 signaling, and detects a start position of the T2 frame. Then, the P1 detection unit 107 supplies, to the operation control unit 121, a result of the determination of a profile of the T2 frame, a result of the analysis of P1 signaling, a result of the detection a start position of the T2 frame.

The operation control unit 121 controls an operation of the P1 detection unit 107 and the OFDM demodulation unit 108 based on the information supplied by the P1 detection unit 107.

For example, based on the information supplied by the P1 detection unit 107, the operation control unit 121 determines whether the received broadcast signal includes a plurality of profiles. Also, when a plurality of profiles is included, the operation control unit 121 determines whether to operate the P1 detection unit 107 and the orthogonal demodulation unit 106 at a start position of a frame of the intended profile (profile for outputting data on which error-correction decoding is performed) and outputs a control signal corresponding to a result of the determination to the P1 detection unit 107 and the OFDM demodulation unit 108.

The above-described control signal is output from the operation control unit 121. Thus, the P1 detection unit 107 and the demodulation unit and the subsequent units are operated in a manner described with reference to FIG. 11. Alternatively, the P1 detection unit 107 and the demodulation unit and the subsequent units are operated, for example, in a manner described with reference to FIG. 13 by the above-described control signal being output from the operation control unit 121.

Note that in a case where a control signal to operate the OFDM demodulation unit 108 is output from the operation control unit 121, the demodulation unit and the subsequent units are operated. In a case where a control signal to pause the OFDM demodulation unit 108 is output from the operation control unit 121, the demodulation unit and the subsequent units are paused.

A configuration of the other part in FIG. 15 is similar to that in the case described with reference to FIG. 8, and thus, detail description thereof is omitted.

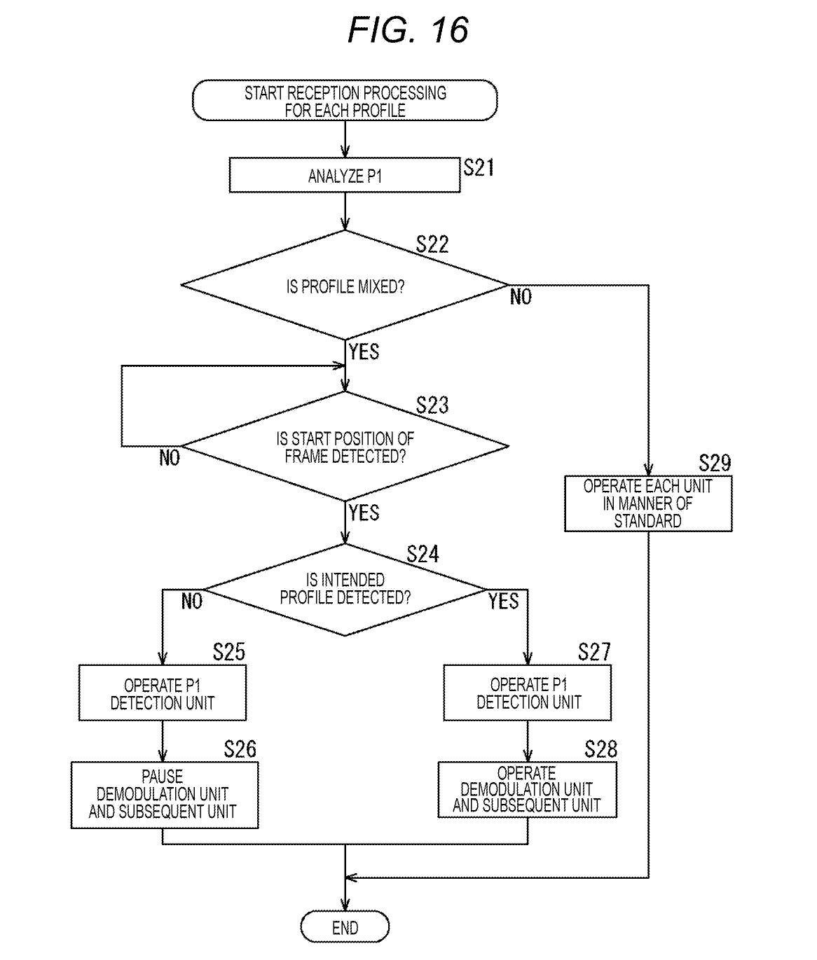

Next, with reference to a flowchart in FIG. 16, an example of reception processing for each profile performed by a transmission apparatus 100 to which the present technique is applied will be described. The processing is an example of when an operation of the reception apparatus 100 is controlled, for example, in a manner described with reference to FIG. 11.

In step S21, the P1 detection unit 107 analyzes P1. Here, for example, information including a result of the determination of a profile of the T2 frame, a result of the analysis of P1 signaling, a result of the detection of a start position of the T2 frame, and the like are supplied to the operation control unit 121.

In step S22, based on information supplied as a result of the processing in step S21, the operation control unit 121 determines whether the received broadcast signal includes a plurality of profiles (whether profile is mixed).

In step S22, when it is determined that profiles are mixed, processing goes to step S23.

In step S23, based on information supplied as a result of the processing in step S21, the operation control unit 121 determines whether a start position of the frame is detected and waits until it is determined that a head position of the frame is detected.

In step S23, when a start position of the frame is detected, processing goes to step S24.

In step S24, the operation control unit 121 determines whether the frame, which is determined in the processing in step S23 that a head position thereof is detected, is a frame of the intended profile.

In step S24, when it is determined that the frame is not a frame of the intended profile, processing goes to step S25.

In step S25, the operation control unit 121 outputs a control signal to operate the P1 detection unit 107.

In step S26, the operation control unit 121 outputs a control signal to pause the OFDM demodulation unit 108.

On the other hand, when it is determined that the frame is not the intended profile in step S24, processing goes to step S27.

In step S27, the operation control unit 121 outputs a control signal to operate the P1 detection unit 107.

In step S28, the operation control unit 121 outputs a control signal to operate the OFDM demodulation unit 108.

Note that when it is determined in step S22 that profiles are not mixed, processing goes to step S29. I step S29, each unit of the reception apparatus 100 is operated in a manner specified in the DVB-T2 standard.

In such a manner, the reception processing for each profile is executed.

Accordingly, an operation of the reception apparatus 100 is controlled, for example, in the manner described with reference to FIG. 11. As a result, when reception of a frame of the intended profile is resumed, it does not take a long period of time for the frequency synchronization, the timing synchronization, and the like and a reception state is not deteriorated.

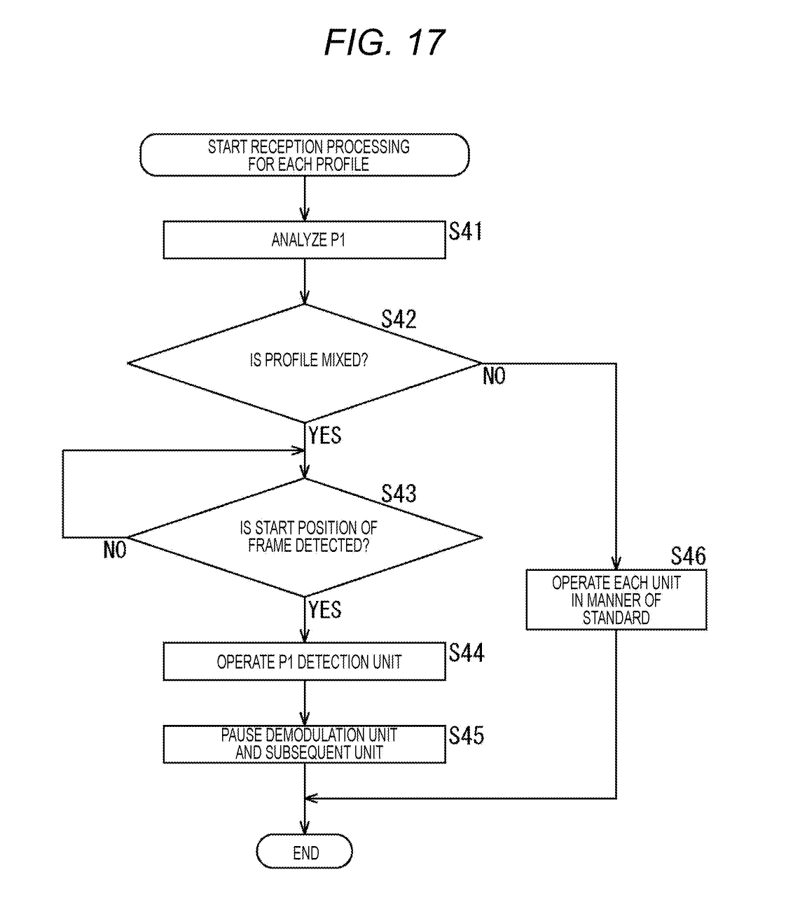

Next, with reference to a flowchart in FIG. 17, a different example of reception processing for each profile performed by the transmission apparatus 100 to which the present technique is applied will be described. The processing is an example of when an operation of the reception apparatus 100 is controlled, for example, in a manner described with reference to FIG. 13.

In step S41, the P1 detection unit 107 analyzes P1. Here, for example, information including a result of the determination of a profile of the T2 frame, a result of the analysis of P1 signaling, a result of the detection of a start position of the T2 frame, and the like are supplied to the operation control unit 121.

In step S42, based on information supplied as a result of the processing in step S21, the operation control unit 121 determines whether the received broadcast signal includes a plurality of profiles (whether profile is mixed).

In step S42, when it is determined that profiles are mixed, processing goes to step S43.

In step S43, based on information supplied as a result of the processing in step S41, the operation control unit 121 determines whether a start position of the frame is detected and waits until it is determined that a head position of the frame is detected.

In step S43, when a start position of the frame is detected, processing goes to step S44.

In step S44, the operation control unit 121 outputs a control signal to operate the P1 detection unit 107.

In step S45, the operation control unit 121 outputs a control signal to operate the OFDM demodulation unit 108.

Note that when it is determined in step S42 that profiles are not mixed, processing goes to step S46. In step S46, each unit of the reception apparatus 100 is operated in a manner specified in the DVB-T2 standard.

In such a manner, the reception processing for each profile is executed.

Accordingly, an operation of the reception apparatus 100 is controlled, for example, in the manner described with reference to FIG. 13.

As a result, even when various profiles are mixed, it becomes possible to perform prediction-type channel estimation, to control memory capacity, and to perform channel estimation with superior noise resistance. Moreover, when reception of a frame of the intended profile is resumed, it does not take a long period of time for the frequency synchronization, the timing synchronization, and the like and a reception state is not deteriorated.

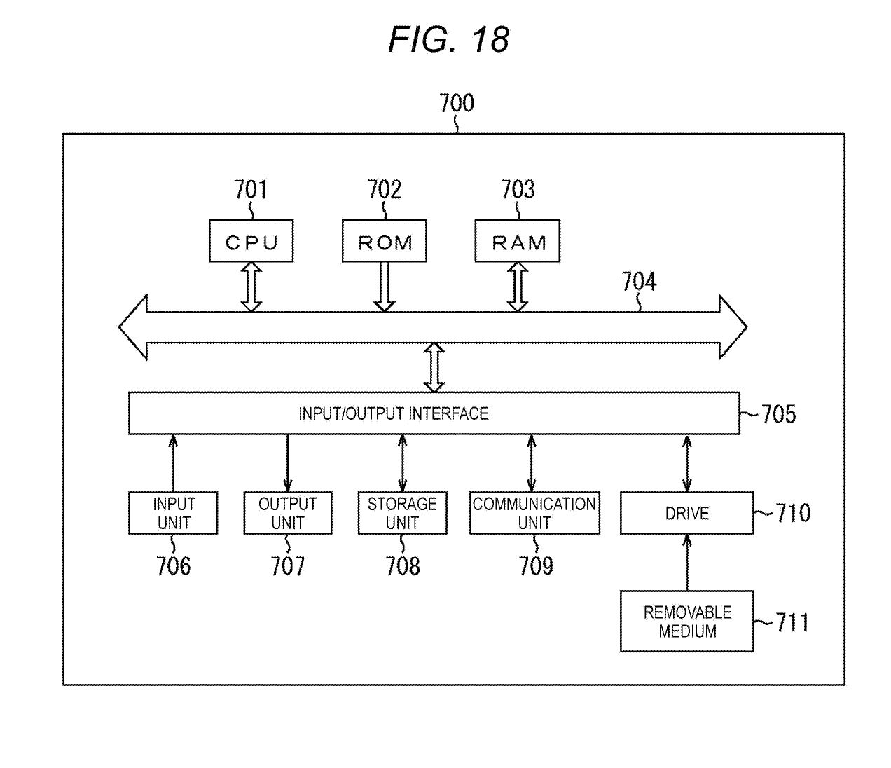

Note that the above-described series of processing can be executed by hardware or by software. In a case where the above-described series of processing is executed by software, by installing a computer, which is embedded into special hardware, or various programs, a program which configures the software is installed from a network or a recording medium into a general personal computer 700 or the like which can execute various functions and which is illustrated, for example, in FIG. 18.

In FIG. 18, a central processing unit (CPU) 701 executes various kinds of processing according to a program stored in a read only memory (ROM) 702 or a program loaded from a storage unit 708 to a random access memory (RAM) 703. Into the RAM 703, data or the like necessary for the CPU 701 to execute various kinds of processing is also stored arbitrarily.

The CPU 701, the ROM 702, and the RAM 703 are connected mutually through a bus 704. To the bus 704, an input/output interface 705 is also connected.

To the input/output interface 705, an input unit 706 including a keyboard, a mouse, or the like, a display including a liquid crystal display (LCD) or the like, an output unit 707 including a speaker or the like, the storage unit 708 including a hard disk or the like, a communication unit 709 including a network interface card such as a modem or a LAN card are connected. The communication unit 709 performs communication processing through a network including the Internet.

Also, to the input/output interface 705, a drive 710 is connected when necessary and a removable medium 711 such as a magnetic disk, an optical disk, a magneto-optical disk, or a semiconductor memory is attached arbitrarily, and a computer program read therefrom is installed into the storage unit 708 when necessary.

In a case where the above-described series of processing is executed by software, a program which configures the software is installed from a network such as the Internet or a recording medium including the removable medium 711 or the like.

Note that the recording medium includes not only what includes the removable medium 711 in which a program is recorded and which is distributed to a user for distribution of the program separately from an apparatus main body as illustrated in FIG. 18 but also what includes a hard disk or the like in which a program is recorded and which is distributed to a user in a state being embedded into the apparatus main body previously. The removable medium 711 includes, for example, a magnetic disk (including floppy disk (registered trademark)), an optical disk (including compact disk-read only memory (CD-ROM) and digital versatile disk (DVD)), a magneto-optical disk (including mini-disk (MD) (registered trademark)), or a semiconductor memory. The hard disk is included in the ROM 702 or the storage unit 708.

Note that the series of processing described in the present description includes not only processing which is performed in the described order in time-series but also processing which is not necessarily performed in time-series but is performed in parallel or individually.

Also, an embodiment of the present technique is not limited to the above-described embodiment and various modifications can be applied thereto within the spirit and the scope of the present technique.

Note that the present technique can include the following configuration.

(1)

A reception apparatus including: an information extraction unit configured to extract, in a broadcast signal which meets a DVB-T2 standard and in which a plurality of profiles is mixed, information included in a frame corresponding to each of the plurality of profiles; and an operation control unit configured to control an operation of the information extraction unit in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.

(2)

The reception apparatus according to (1), wherein the information which is included in the frame of the second profile and which is necessary for the processing related to the frame synchronization is a P1 preamble signal.

(3)

The reception apparatus according to (1) or (2), wherein the information which is included in the frame of the second profile and which is necessary for the processing related to the frame synchronization is a scattered pilot signal or a continual pilot signal.

(4)

The reception apparatus according to any of (1) to (3), wherein frequency synchronization in the frame of the first profile is performed based on the information which is included in the frame of the first profile and which is necessary for the processing related to the frame synchronization and the information which is included in the frame of the second profile and which is necessary for the processing related to the frame synchronization, the information being extracted by the information extraction unit.

(5)

The reception apparatus according to any of (1) to (4), wherein timing synchronization in the frame of the first profile is performed based on the information which is included in the frame of the first profile and which is necessary for the processing related to the frame synchronization and the information which is included in the frame of the second profile and which is necessary for the processing related to the frame synchronization, the information being extracted by the information extraction unit.

(6)

The reception apparatus according to any of (1) to (5), wherein channel estimation in the frame of the first profile is performed based on the information which is included in the frame of the first profile and which is necessary for the processing related to the frame synchronization and the information which is included in the frame of the second profile and which is necessary for the processing related to the frame synchronization, the information being extracted by the information extraction unit.

(7)

The reception apparatus according to (6), wherein a scattered pilot signal is extracted as the information which is included in the frame of the second profile and which is necessary for the processing related to the frame synchronization, a scattered pilot signal of the frame of the first profile is predicted based on the scattered pilot signal extracted from the frame of the second profile, and channel estimation in the frame of the first profile is performed based on the predicted scattered pilot signal.

(8)

A reception method including: extracting, in a broadcast signal which meets a DVB-T2 standard and in which a plurality of profiles is mixed, information included in a frame corresponding to each of the plurality of profiles, the extracting being performed by an information extraction unit; and controlling an operation of the information extraction unit, which is performed by an operation control unit, in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.

(9)

A non-transitory computer-readable recording medium storing a program for causing a computer to function as a reception apparatus including: an information extraction unit configured to extract, in a broadcast signal which meets a DVB-T2 standard and in which a plurality of profiles is mixed, information included in a frame corresponding to each of the plurality of profiles; and an operation control unit configured to control an operation of the information extraction unit in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.

### REFERENCE SIGNS LIST

100 reception apparatus

101 tuner

106 orthogonal demodulation unit

107 P1 detection unit

108 OFDM demodulation unit

109 error-correction decoding unit

110 L1 interpretation unit

111 waveform shaping unit

121 operation control unit

1. A reception apparatus comprising:
an information extraction unit configured to extract, in a broadcast signal which meets a DVB-T2 standard and in which a plurality of profiles is mixed, information included in a frame corresponding to each of the plurality of profiles; and
an operation control unit configured to control an operation of the information extraction unit in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.

2. The reception apparatus according to claim 1, wherein the information which is included in the frame of the second profile and which is necessary for the processing related to the frame synchronization is a P1 preamble signal.

3. The reception apparatus according to claim 1, wherein the information which is included in the frame of the second profile and which is necessary for the processing related to the frame synchronization is a scattered pilot signal or a continual pilot signal.

4. The reception apparatus according to claim 1, wherein frequency synchronization in the frame of the first profile is performed based on the information which is included in the frame of the first profile and which is necessary for the processing related to the frame synchronization and the information which is included in the frame of the second profile and which is necessary for the processing related to the frame synchronization, the information being extracted by the information extraction unit.

5. The reception apparatus according to claim 1, wherein timing synchronization in the frame of the first profile is performed based on the information which is included in the frame of the first profile and which is necessary for the processing related to the frame synchronization and the information which is included in the frame of the second profile and which is necessary for the processing related to the frame synchronization, the information being extracted by the information extraction unit.

6. The reception apparatus according to claim 1, wherein channel estimation in the frame of the first profile is performed based on the information which is included in the frame of the first profile and which is necessary for the processing related to the frame synchronization and the information which is included in the frame of the second profile and which is necessary for the processing related to the frame synchronization, the information being extracted by the information extraction unit.

7. The reception apparatus according to claim 6, wherein a scattered pilot signal is extracted as the information which is included in the frame of the second profile and which is necessary for the processing related to the frame synchronization,
a scattered pilot signal of the frame of the first profile is predicted based on the scattered pilot signal extracted from the frame of the second profile, and
channel estimation in the frame of the first profile is performed based on the predicted scattered pilot signal.

8. A reception method comprising:
extracting, in a broadcast signal which meets a DVB-T2 standard and in which a plurality of profiles is mixed, information included in a frame corresponding to each of the plurality of profiles, the extracting being performed by an information extraction unit; and
controlling an operation of the information extraction unit, which is performed by an operation control unit, in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.

9. A non-transitory computer-readable recording medium storing a program for causing a computer to function as a reception apparatus including:
an information extraction unit configured to extract, in a broadcast signal which meets a DVB-T2 standard and in which a plurality of profiles is mixed, information included in a frame corresponding to each of the plurality of profiles; and
an operation control unit configured to control an operation of the information extraction unit in such a manner that information which is included in a frame of a first profile and which is necessary for processing related to frame synchronization and information which is included in a frame of a second profile and which is necessary for the processing related to the frame synchronization are constantly acquired among the plurality of profiles, the first profile being a profile for outputting data on which error-correction decoding is performed, and the second profile being a profile for not outputting data on which the error-correction decoding is performed.
